(19) United States
(12) Patent Application Publication
(10) Pub. No.: US 2012/0048191 A1
(43) Pub. Date: Mar. 1, 2012

(54) Transmission Device for Radiation

(75) Inventors: Johannes SCHMID, Starzach/Wachendorf (DE); Axel PETRAK, Horb am Neckar (DE)

(73) Assignee: HOMAG HOLZBEARBEITUNGSSYSTEME AG, Schopfloch (DE)

(21) Appl. No.: 13/216,292

(22) Filed: Aug. 24, 2011

(30) Foreign Application Priority Data
Aug. 24, 2010 (EP) 10173828.4

(51) Int. Cl. B05C 5/00

(52) U.S. Cl. 118/620

(57) ABSTRACT

The invention relates to an apparatus (1) for coating workpieces which are preferably made at least in sections of wood, wood materials, plastic or the like, comprising a radiation source for generating radiation, preferably a laser beam. The apparatus further comprises a unit (10) for applying the coating material to a surface of a workpiece, and a transmission device (2) for transmitting the radiation from the radiation source to the unit. The apparatus according to the invention is characterised in that the unit (10) can be moved actively and/or passively relative to the radiation source, and the transmission device has a conductor (12), preferably a fibre optic cable.

### TECHNICAL FIELD

The invention relates to a transmission device for transmitting radiation. The radiation is generated in a radiation source and relayed at least partially by the transmission device into a unit. The unit is part of an apparatus for coating workpiece surfaces with a coating material. These workpieces are preferably made at least in sections of wood, wood materials, plastic or the like.

These apparatuses are suitable for use in wood processing, in particular for the furniture and components industry.

### PRIOR ART

Radiation, in particular laser radiation, has a wide range of possibilities for application in production processes, e.g. when separating, joining or labelling. In wood processing laser radiation is also used, among other things, for coating the surfaces of workpieces with a coating material. In this process the laser radiation is generated by an energy source and then relayed to the active region. The challenge is to implement the relaying of the radiation from the energy source to the active region with as few losses as possible and to seal it off hermetically from the surrounding area. Generally apparatuses which guarantee this relaying comprise optical elements such as for example mirrors, which deflect the radiation. However, a disadvantage with this type of structure is its complexity. Furthermore, it is difficult to shield it from the surrounding area. This results in high costs for these types of apparatus. Only in this way can the risk of radiation escaping be reduced, and this would lead to a potential hazard for the area surrounding this type of apparatus. This must, however, be avoided under all circumstances.

Furthermore, a disadvantage of relaying the radiation by means of optics is a small degree of flexibility. This applies both to the adaptation of the apparatus to different production tasks as well as to the adaptation of the apparatus during production.

### DESCRIPTION OF THE INVENTION

Therefore, the object forming the basis of the invention is to design an apparatus for conveying radiation such that the latter takes place efficiently and avoiding any risk to the area surrounding the apparatus. Furthermore, this apparatus should offer or open up the possibility of being able to adapt to changing production tasks.

This object is solved by the invention having the features of Claim 1. Advantageous embodiments of the apparatus according to the invention are given by the sub-claims.

The invention is based upon the idea of forming, with its aid, a unit in which the active region of the radiation is located and which can be moved actively and/or passively relative to the radiation source. For this purpose a transmission device has been invented in which a conductor, preferably a fibre optic cable, guarantees relaying of the radiation into the unit.

By integrating this transmission device the unit has a wide variety of possibilities for use. The versatility lies, for example, in the adaptability to the required range of movement of the unit during a coating process. The transmission device thus enables by the use of a conductor conveying the radiation use with large required movement ranges (stationary technology) and equally with only small requirements with regard to moveability (through-feed technology). It is thus possible to process workpieces both with a complex geometry and with a simple geometry. The use of a conductor, preferably a fibre optic cable, enables transmission here almost without any losses, combined with a long life and only low maintenance costs.

In one preferred embodiment of the apparatus according to the invention the transmission device has a point leading into the conductor that is fixed in relation to the pivot point of the unit as well as a point relaying into the unit that is fixed in relation to the unit. Here preferably at least one component forming part of the unit is attached to the relaying point, said component preferably changing the geometry, direction or strength of the radiation. By means of the lead-in point fixed in relation to the pivot point of the unit and the relaying point fixed in relation to the unit it is guaranteed that any change to the alignment between the unit and the radiation source can be compensated within the region between the lead-in point and the relaying point. Conversely, the consequence of this is that rotation is avoided between the radiation source and the lead-in point as well as between the relaying point and the unit, and when using a supplying conductor this would lead, for example, to undesired torsional loads.

In one preferred embodiment of the apparatus according to the invention there is located between the radiation source and the lead-in point preferably at least one connection element. This connection element can be, for example, a fibre optic cable, in particular with a fibre coupling, or some other optical element. The latter possibly changes the direction, geometry or strength of the radiation. Furthermore, it can be advantageous to design this connection element to be releaseable and fixable. The releaseability and fixability of the connection element should preferably be repeatable here without any restriction of the number of these processes. It is an advantage with this type of design of the connection element that the unit with the transmission device can be uncoupled from the radiation source. This may be necessary in order, for example, to change a defective unit and/or a defective radiation source or to eliminate a defect. Furthermore, this type of repeatable coupling and uncoupling of the connection element advantageously opens up the possibility of using units adapted to different production tasks, and so increases the vertical production range of the apparatus.

In a further preferred embodiment of the present invention there is located between the relaying point and a component located within the unit at least one connection element. This connection element is preferably in the form of a fibre optic cable, in particular with a fibre coupling, or of some other optical element. It is to be considered advantageous here if the connection element can be coupled and uncoupled, and if this process can be repeated as often as one wishes. The advantage of this is that the unit can be totally uncoupled from the transmission device and the radiation source.

It is thus possible, for example, in a simple way, to change a defective unit and/or a defective radiation source quickly and inexpensively, and to carry out repairs without interrupting the coating process. Furthermore, it is possible by changing the unit to adapt the latter to the respective requirements of the coating process, and so to increase the vertical production range of the coating apparatus.

In a particularly preferred embodiment of the apparatus according to the invention the transmission device comprises at least one circulatory element, for example in the form of a disc, the centre point of at least one circulatory element corresponding to the axis of rotation or the pivot point of the unit. Here the conductor, which is located between the lead-in point and the relaying point, circulates at least partially round the circulatory element. The extent of circulating of the conductor changes with the extent of rotation of the unit relative to the energy source.

The advantage of using a circulatory element is rotation of the unit relative to the energy source by defined winding and unwinding. The advantage of the centre point of the circulatory element corresponding to the axis of rotation of the unit is that, from the point of view of a global co-ordinate system, the rotational movement of the unit during the coating process only also acts as rotation onto the circulatory element. In contrast, a centre point of the circulatory element not lying on the axis of rotation of the unit would result in there being combined translation and rotation of the circulatory element from the point of view of a global co-ordinate system with rotation of the unit. This requires a higher degree of moveability of the conductor which can be associated at least partially with increased bending or even torsion.

However, fibre optic cables only enable loss-free transmission of the radiation provided that they are not strongly bent or twisted. In addition, fibre optic cables are mostly made of mineral glass or organic glass, and so easily crack and break when subjected to mechanical loading. The advantage of the centre point of the circulatory element corresponding to the axis of rotation of the unit is that a loss of energy occurring through the outside of the conductor due to bending, or cracking and breaking of the conductor is prevented. Situations which in connection with this are associated with a risk to the area surrounding the coating apparatus will thus be avoided. This in turn contributes to increasing operational safety.

In a further preferred embodiment of the invention at least two circulatory elements can be moved towards and away from one another and actively or passively relative to one another. Due to the extent of the circulation of the conductor around the circulatory element over the course of operation of the unit the effective conductor length between the lead-in and relaying point changes. The circulatory elements that can be moved relative to one another have the advantage that they compensate for the change to the effective conductor length, and so guarantee a defined winding path of the conductor in the transmission device.

In a further particularly preferred embodiment of the invention at least one circulatory element has at least two support elements which are formed such that they can be displaced actively or passively relative to the centre point of the circulatory element. The conductor circulates here at least partially round the support elements applied to the circulatory element. The particular advantage of this embodiment is that by displacing the support elements the radius of the circulatory element can be adapted. This adaptation preferably takes place dependently upon the rotation of the unit around the axis of rotation of the latter. Thus a single circulatory element with this structure can suffice in order to guarantee the necessary adaptation of the effective conductor length when moving the unit.

In a further preferred embodiment of the apparatus according to the invention at least one circulatory element is mounted fixed or rotatable relative to the unit. The result of this is that, depending on the embodiment, a relative movement between the conductor and the circulatory element can occur during the winding process. If the circulatory element is mounted rotatably relative to the unit, a relative movement between the conductor and the circulatory element during winding is prevented. If the circulatory element is mounted fixed relative to the unit, the conductor winds around the circulatory element by sliding over the circulatory element and/or the support elements of the latter. A fixedly mounted circulatory element has the advantage of a very simple structure, whereas the result of a rotatably mounted circulatory element is less loading of the conductor and the surface thereof. However, even with a fixed circulatory element it is conceivable to achieve preservation of the conductor over a sliding surface located on the circulatory element.

In one preferred embodiment of the apparatus according to the invention the conductor circulates around at least one circulatory element in a spiral or helical form. The advantage of this is that the conductor winds in a defined manner when it circulates around the circulatory element a number of times, and the conductor does not cross over itself during the winding process.

In a further embodiment of the present invention the unit is designed to fit interchangeably into an appropriate retainer, in particular a spindle unit. The interchangeability of the unit by means of a retainer (in particular a spindle unit) has the advantage that in the event of maintenance, repair or retrofitting of the apparatus, the latter can be implemented simply, quickly and inexpensively. Furthermore, a result of this advantageous embodiment is that in its functional range different units can be integrated into the coating apparatus, and so the functional range of the production machine can be extended arbitrarily.

In a further preferred embodiment of the apparatus according to the invention energy and/or signals can be transmitted with the aid of the radiation. Above all, additional transmission of signals during the production process or before or after the production process opens up the possibility of controlling the unit by means of the radiation. It is thus conceivable that the components, which change the geometry, direction or strength of the radiation, can be influenced in the implementation of their task to the point of their respective functions being switched on and off.

### BRIEF DESCRIPTION OF THE FIGURES

FIG. 1 shows diagrammatically the coating apparatus comprising the unit and transmission apparatus. The transmission device comprises a circulatory element and four moveable support elements.

FIG. 2 shows diagrammatically a unit with the transmission device which comprises two circulatory elements.

FIG. 3 shows diagrammatically a transmission device consisting of a circulatory element and four moveable support elements.

### DETAILED DESCRIPTION OF PREFERRED EMBODIMENTS OF THE INVENTION

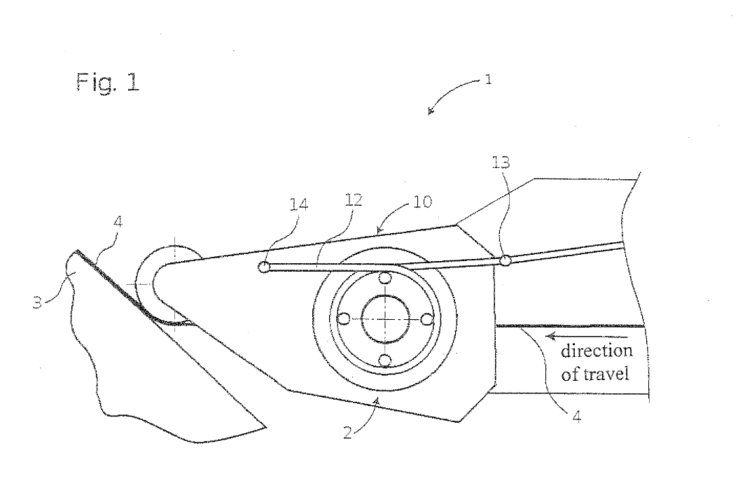

A coating apparatus 1, as a preferred embodiment of the invention, is shown diagrammatically in a top view in FIG. 1. The coating apparatus 1 serves to coat workpieces 3 with a coating material 4, for example in the field of the furniture and components industry. These are preferably made at least in sections of wood, wood materials, plastic or the like, although the invention is not restricted to these.

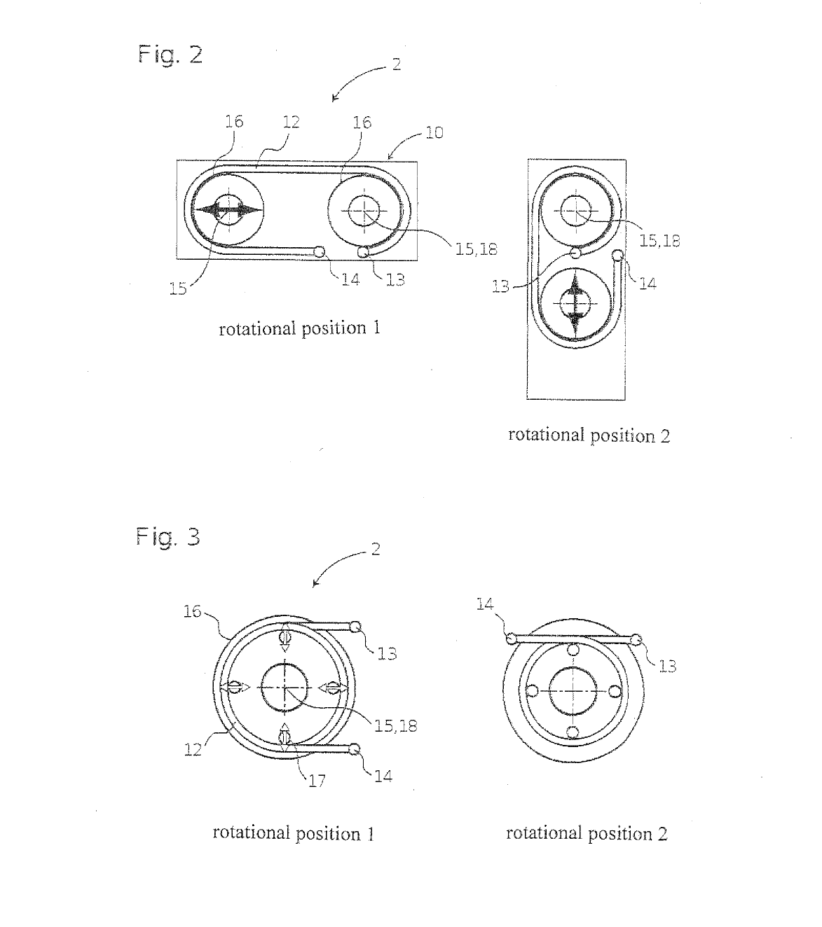

The apparatus 1 comprises a (coating) unit 10 comprising a transmission device 2. The transmission device 2 is shown in two different rotational positions in FIG. 2—on the one hand in rotational position 1, and on the other hand rotated by 90° in the anti-clockwise direction in rotational position 2. Here the rotation about 90° is an example chosen purely at random, and can be replaced by any number of degrees which also include multiple rotations. In the embodiment in FIG. 2 the lead-in point 13 is fixed in relation to the pivot point of the unit 18. Following after the lead-in point 13 is a conductor 12, preferably a fibre optic cable, that connects the lead-in point 13 to the relaying point 14. Differently from the lead-in point 13, the relaying point 14 is fixed in relation to the unit 10. Here the radiation can access the lead-in point 13 from any direction. The lead-in point 13 does not have to be in the position shown in FIG. 2 either, but it can also adopt any other position on the unit 10. The same applies accordingly to the relaying point 14.

After the lead-in point 13 the conductor initially circulates around a first circulatory element 16, the centre point of which, as described above, advantageously corresponds to the axis of rotation 18 of the unit 10. Here the circulatory element 16 can be mounted fixed or rotatable in relation to the unit 10. In the embodiment in FIG. 2 there is lying opposite on the same surface of the unit 10 a second circulatory element 16 around which the conductor circulates after the first circulatory element 16. Here the second circulatory element 16 can be displaced relatively actively or passively in the direction or counter-direction of the first circulatory element 16. Furthermore, it is possible to mount the second circulatory element 16 fixed or moveably in its rotatory degree of freedom. The conductor 12 circulating around the two circulatory elements 16 most preferably only circulates around the diversion elements once here in order to avoid multiple deflection of the fibre optic cable.

The unit 10 located in the rotational position 2 in FIG. 2 illustrates the mode of operation of this embodiment. The lead-in point 13 lying fixed in relation to the pivot point of the unit 18 has kept its position. By rotating about the axis of rotation 18 by 90° in the anti-clockwise direction the conductor 12 now has to circulate around the first circulatory element 16 by an additional quarter rotation. Due to the additional circulation of the conductor 12 around the circulatory element 16 the effective conductor length is shortened, and this is compensated by shortening the distance between the first circulatory element 16 and the second circulatory element 16 by the corresponding arc length of the rotation about 90° around the circulatory element 16. A particular advantage with this embodiment is the defined, and at the same time arbitrary radius around which the conductor 12 circulates. By the specific choice of bending radius which is thus possible, loss of energy when transmitting the radiation or even damage to the conductor by the transmission device can thus be prevented.

The embodiment of the transmission device in FIG. 3 only comprises one circulatory element 16 on which a total of four support elements 17 are fastened which can move in the direction and counter-direction of the centre point of the circulatory element 16. The exemplary embodiment in FIG. 3 is also shown here for two different rotational positions. On the one hand, in the initial position—rotational position 1—and on the other hand after rotating about the axis of rotation of the unit 10 by 180° in the anti-clockwise direction. Here the conductor 12 can circulate around the support elements 17 on the circulatory element 16 shown as often as one chooses, the circulation around the circulatory element 16 preferably following a spiral or helical path. However, in order to keep energy losses as low as possible and to subject the conductor to as little bending as possible, it is preferable if there is as little circulation as possible around the support elements 17. In the embodiment shown in FIG. 3, the centre point of the circulatory element 16 is preferably located on the axis of rotation 18 of the unit 10.

After rotation by 180° the lead-in point 13, fixed in relation to the pivot point 18 of the unit, is furthermore in the same position as considered from the point of view of the global co-ordinate system. In contrast, the relaying point 14, which is fixed in relation to the unit 10, has changed its position according to the rotation of the unit 10 that has been implemented. The conductor 12 now circulates around the support elements 17 by an additional half rotation. The shortening of the effective conductor length caused by the additional half rotation is compensated by a movement of the support elements 17 to the centre point 15, the result being a reduction of the circulation radius.

The advantage of this embodiment is in particular its compact design. The support elements 17 are preferably shifted coupled to the rotation of the unit about the axis of rotation 18. Furthermore, the advantage of the embodiment in FIG. 3 is that the compact design and construction also enable multiple rotations of the unit 10.

As an alternative, it is possible in a further advantageous embodiment to compensate for a change to the effective conductor length by a conical form of the rotating element. The diameter of the cone, and so the circumference of the cone, change over the height of the cone. In this way a change to the effective conductor length caused by the unit rotation can be compensated by active and/or passive positioning of the circulating conductor over the height of the cone.

Basically, it is possible to design the unit 10 to be interchangeable by means of a spindle. Likewise, however, it is also possible to integrate the unit as a permanent component into the apparatus 1.

1. An apparatus for coating workpieces which are preferably made at least in sections of wood, wood materials, plastic or the like, comprising;
a radiation source for generating radiation;
a unit for applying a coating material to a surface of a workpiece, and
a transmission device for transmitting the radiation from the radiation source to the unit, wherein
the unit can be moved actively and/or passively relative to the radiation source, and
the transmission device has a conductor.

2. The apparatus according to claim 1, wherein the transmission device is disposed between the radiation source and the unit and has a point leading into the conductor that is fixed in relation to a pivot point of the unit and a relaying point that is fixed in relation to the unit to which at least one component forming part of the unit is attached.

3. The apparatus according to claim 2, wherein there is located between the radiation source and the lead-in point at least one connection element.

4. The apparatus according to claim 2, wherein there is located between the relaying point and a component located within the unit at least one connection element.

5. The apparatus according to claim 1 wherein the transmission device comprises at least one circulatory element, a centre point of at least one circulatory element corresponding to the pivot point of the unit and at least one circulatory element being circulated by the conductor at least once.

6. The apparatus according to claim 5, wherein at least two circulatory elements can be moved towards and away from one another actively or passively relative to one another.

7. The apparatus according to claim 5, wherein there are integrated into at least one circulatory element at least two support elements which can be displaced actively or passively relative to the centre point of the circulatory element, and the conductor circulates around the circulatory element via the support elements.

8. The apparatus according to claim 5, wherein at least one circulatory element is mounted fixed or rotatable relative to the unit.

9. The apparatus according to claim 5, wherein the conductor circulates around at least one circulatory element in a spiral or helical form.

10. The apparatus according to claim 1, wherein the unit is designed to fit interchangeably into an appropriate retainer.

11. The apparatus according to claim 1, wherein energy and/or signals are transmitted with the radiation.

12. The apparatus according to claim 1, wherein said radiation sources is a laser beam.

13. The apparatus according to claim 1, wherein said conductor is a fibre optic cable.

14. The apparatus according to claim 2, wherein the component is capable of changing the geometry, direction and/or strength of the radiation.

15. The apparatus according to claim 3, wherein a connection point is in the form of a fibre optic cable including a fibre coupling or other optical element.

16. The apparatus according to claim 4, wherein a connection point is in the form of a fibre optic cable including a fibre coupling or other optical element.

17. The apparatus according to claim 5 wherein the circulatory element is a disc or cone.

18. The apparatus according to claim 10, wherein the retainer is a spindle unit.
